(19) United States
(12) Patent Application Publication
(10) Pub. No.: US 2020/0402093 A1
(43) Pub. Date: Dec. 24, 2020

(54) MANAGING AND ADMINISTRATING REWARDS FOR A PLURALITY OF MERCHANTS

(71) Applicant: PAYPAL, INC., San Jose, CA (US)

(72) Inventors: Sanika Vilas Nikam, San Jose, CA (US); Sarah Mackey, San Francisco, CA (US); Li Chen, San Jose, CA (US); Veena Bontu, San Jose, CA (US)

(21) Appl. No.: 16/449,679

(22) Filed: Jun. 24, 2019

(51) Int. Cl. G06Q 30/02

(52) U.S. Cl. CPC G06Q 30/0229; G06Q 30/0233

(57) ABSTRACT

In response to detecting a first purchase or a user activity by a user and corresponding to a first merchant, a computer system, updates a rewards amount associated with the user, the first merchant corresponding to a first rewards program. The computer system detects an initiation of a second purchase by the user, the purchase corresponding to a second merchant, wherein the second merchant does not correspond to the first rewards program. In response to detecting the initiation of the second purchase, the computer system causes an interface to be provided to the user, wherein the interface allows the first user to utilize at least a portion of the rewards amount for the second purchase. In response to receiving an input from the first user via the provided interface, the computer system processes a payment for the second purchase, utilizing at least a first portion of the rewards amount.

### TECHNICAL FIELD

The present disclosure relates to a rewards program, and more particularly to a system and method for managing and administering rewards for a plurality of merchants.

### BACKGROUND

The payments landscape has changed drastically over the past decade. This is primarily due to financial technology platforms that have allowed consumers to have simple and frictionless shopping experiences online, while also allowing consumers to transfer money to their family and friends via their computers and mobile devices. Furthermore, with the number of merchants and service providers that utilize financial technology platforms to accept payments from their customers, there is an opportunity for financial technology platforms to create a rewards program that is applicable and redeemable across multiple associated merchants. This may result in an easier onboarding and reward redemption process for customers, which may represent an improvement over current rewards system that are only applicable to merchants that have been onboarded to the specific rewards program.

### BRIEF DESCRIPTION OF THE DRAWINGS

FIG. 1 illustrates a payment system, in accordance with an embodiment.

FIG. 2 is a flowchart illustrating the operations of the payment application of FIG. 1 in providing an interface for a user to utilize a rewards program to make a purchase with a merchant that is not part of the rewards program, in accordance with an embodiment.

FIG. 3 is a flowchart illustrating the operations of the payment application of FIG. 1 in providing an indication of rewards availability to a user within an interface of a merchant that is not associated with the rewards program, in accordance with an embodiment.

FIG. 4 is a flowchart illustrating the operations of the payment application of FIG. 1 in determining if a change to a rewards program corresponds to a profile of a user, in accordance with an embodiment.

FIG. 5 is a depiction of a checkout page on a merchant website that includes an option to utilize rewards for a purchase, in accordance with an embodiment.

FIG. 6 is a depiction of an interface provided by the payment application of FIG. 1 that allows a user to utilize rewards to pay with a merchant that is not onboarded with the rewards program, in accordance with an embodiment.

FIG. 7 is a block diagram depicting the hardware components of the payment system of FIG. 1, in accordance with an embodiment.

### DETAILED DESCRIPTION

Embodiments of the present disclosure provide a system, method, and program product. In response to detecting a first purchase or a user activity by a user and corresponding to a first merchant, a computer system updates a rewards amount associated with the user, the first merchant corresponding to a first rewards program. The computer system detects an initiation of a second purchase by the user, the purchase corresponding to a second merchant, wherein the second merchant does not correspond to the first rewards program. In response to detecting the initiation of the second purchase, the computer system causes an interface to be provided to the user, wherein the interface allows the first user to utilize at least a portion of the rewards amount for the second purchase. In response to receiving an input from the first user via the provided interface, the computer system processes a payment for the second purchase, utilizing at least a first portion of the rewards amount.

In response to detecting a first purchase or a user activity by a first user and corresponding to a first merchant, the computer system updates a rewards amount associated with the first user, wherein the first merchant corresponds to a first rewards program. In response to detecting an accessing of a checkout page of a webpage or application page of a second merchant, the computer system determines if the second merchant corresponds to the first rewards program. In response to the determining that the second merchant does not correspond to the first rewards program, the computer system causes an indication of a rewards availability for the second merchant to be provided to the first user. In response to detecting an initiation of a second purchase, the computer system causes an interface to be provided to the first user, wherein the interface provides a selectable option that corresponds to utilizing at least a portion of the rewards amount for the second purchase. In response to receiving an input from the first user via the provided interface, the computer system processes a payment for the second purchase, wherein at least a first portion of the rewards amount is utilized for the payment.

As stated above, current rewards programs only apply to a merchant or a group of merchants that are associated or have been onboarded with the rewards program. This may limit the ability for a consumer to utilize accumulated rewards. In the example embodiment, the present disclosure describes a solution that allows for a user of a service provider to utilize rewards accumulated with a first merchant (or a first plurality of merchants), onboarded with a rewards program administered by the service provider, to pay for a purchase with a second merchant (or second plurality of merchants) that is not onboarded with the rewards program administered by the service provider. In the example embodiment, the present disclosure describes detecting a purchase by a user on a first merchant website, and, based on determining that the first merchant is onboarded with the rewards program administered by the service provider, a rewards total associated with the user is updated based on the purchase. Based on a user accessing a checkout page associated with a second merchant that is not be onboarded with the rewards program, the present disclosure describes detecting if a user interface element associated with the service provider of the payment application has been accessed, and based on detecting that the user interface element has been accessed, the present disclosure provides a solution that allows the user to utilize the accumulated rewards to pay for a purchase with the second merchant within the payment application. In the example embodiment, the service provider may provide payment solutions to the second merchant (the second merchant may be onboarded with the service provider with regard to payment solutions, however, may not be onboarded for the rewards program).

Additionally, the present disclosure describes a solution that detects a rewards change associated with a merchant, such as change to a points scheme or redemption scheme. Based on determining the rewards change, the present disclosure describes determining if the rewards change corresponds to a user profile associated with a user, and based on determining that the rewards change corresponds to the user profile associated with the user, the present disclosure provides a notification to the user.

Embodiments of the present disclosure will now be described in detail with reference to the accompanying Figures.

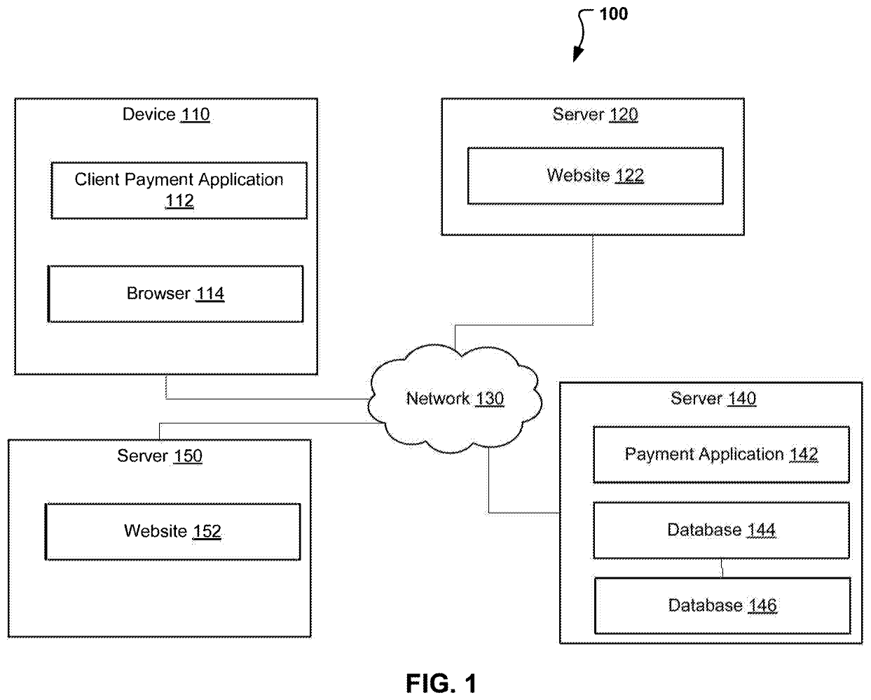

FIG. 1 illustrates rewards system 100, in accordance with an embodiment. In the example embodiment, rewards system 100 includes device 110, server 120, server 140, and server 150 interconnected via network 130.

In the example embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a Bluetooth network, a local area network (LAN), or a wide area network (WAN). In general, network 130 can be any combination of connections and protocols that will support communications between computing devices, such as between device 110 and server 140.

In the example embodiment, server 120 includes website 122. In the example embodiment, server 120 is a server of a merchant or a service provider, however, in other embodiments, server 120 may correspond to a different type of entity. In the example embodiment, server 120 may be a desktop computer, a laptop computer, a tablet computer, a mobile device, a handheld device, a thin client, or any other electronic device or computing system capable of receiving and sending data to and from other computing devices, such as device 110, via network 130. Although not shown, optionally, server 120 can comprise a cluster of, servers executing the same software to collectively process requests as distributed by a front-end server and a load balancer. In the example embodiment, server 120 is a computing device that is optimized for the support of websites that reside on server 120, such as website 122, and for the support of network requests related to websites, which reside on server 120. Server 120 is described in more detail with regard to the figures.

In the example embodiment, website 122 is a collection of files including, for example, HTML files, CSS files, image files and JavaScript files. Website 122 may also include other resource files such as audio files and video files. In the example embodiment, website 122 is a merchant or service provider website, however, in other embodiments, website 122 may be another type of website. Website 122 is described in more detail with regard to the figures.

In the example embodiment, server 150 includes website 152. In the example embodiment, server 150 is a server of a merchant or a service provider, however, in other embodiments, server 150 may correspond to a different type of entity. In the example embodiment, server 150 may be a desktop computer, a laptop computer, a tablet computer, a mobile device, a handheld device, a thin client, or any other electronic device or computing system capable of receiving and sending data to and from other computing devices, such as device 110, via network 130. Although not shown, optionally, server 150 can comprise a cluster of servers executing the same software to collectively process requests as distributed by a front-end server and a load balancer. In the example embodiment, server 150 is a computing device that is optimized for the support of websites that reside on server 150, such as website 152, and for the support of network requests related to websites, which reside on server 150. Server 150 is described in more detail with regard to the figures.

In the example embodiment, website 152 is a collection, of files including, for example, HTML files, CSS files, image files and JavaScript files. Website 152 may also include other resource files such as audio files and video files. In the example embodiment, website 152 is a merchant or service provider website, however, in other embodiments, website 152 may be another type of website. Website 152 is described in more detail with regard to the figures.

In the example embodiment, device 110 includes client payment application 112 and browser 114. In the example embodiment, device 110 may be a desktop computer, a laptop computer, a tablet computer, a mobile device, a handheld device, a thin diem, or any other electronic device or computing system capable of receiving and sending data to and from other computing devices, such as server 140, via network 130. Device 110 is described in more detail with regard to the figures.

In the example embodiment, client payment application 112 is a diem-side application, corresponding to the server-side payment application 142, that is capable of transmitting requests to payment application 142 and is further capable of providing received information to a user of device 110 via a user interface. Client payment application 112 is described in more detail with regard to the figures.

In the example embodiment, browser 114 is an application that is capable of communicating with other computing devices to transmit request and a receive information. Furthermore, browser 114 is capable of displaying received information to the user of device 110. In the example embodiment, browser 114 may transmit a request to website 122, and further receive webpage information from website 122. Browser 114 is described in further detail with regard to the figures.

In the example embodiment, server 140 includes payment application 142, database 144, and database 146. In the example embodiment, server 140 may be a desktop computer, a laptop computer, a tablet computer, a mobile device, a handheld device, a thin client, or any other electronic device or computing system capable of receiving and sending data to and from other computing devices, such as device 110, via network 130. Although not shown, optionally, server 140 can comprise a cluster of servers executing the same software to collectively process requests as distributed by a front-end server and a load balancer. In the example embodiment, server 140 is a computing device that is optimized for the support of applications that reside on server 140, such as payment application 142, and for the support of network requests related to payment application 142. Server 140 is described in more detail with regard to the figures.

In the example embodiment, database 144 is a database that includes information that corresponds to one or more users of the service provider associated with server 140, such as one or more user preferences, user transactional history, user transaction habits, user financial information, user authentication information, user preferences, user connections (other users that a user may be linked to, connected with, etc.), and additional user information. Furthermore, in the example embodiment, database 144 may include information as to rewards that have been accumulated by one or more users, such as the user of device 110 via transactions/user activity, etc. Database 144 is described in more detail with regard to the figures.

In the example embodiment, database 146 is a database that includes information that corresponds to one or more merchants that are associated with the service provider corresponding to payment application 142. For example, database 146 may include information such as merchant transactional information, merchant preferences, merchant financial information, and additional user information. Furthermore, in the example embodiment, database 146 may include information as to whether each of the one or more merchants have been onboarded with a rewards program administered/managed by the service provider associated with payment application 142, and further may include information as to one or more accumulation or point redemption schemes associated with the one or more merchants. Database 144 is described in more detail with regard to the figures.

In the example embodiment, payment application 142 is a server-side application, corresponding to the client-side applications such as client payment application 112. While in the example embodiment, payment application 142 is a payment application, in other embodiments, payment application 142 (and the corresponding client applications) may be a social media application, an e-commerce application, or a different type of application. In the example embodiment, payment application 142 is capable of receiving information from client applications and further capable of responding to requests from corresponding client applications. In addition, in the example embodiment, payment application 142 is capable of detecting a purchase made by a user, such as the user of device 110, on a first merchant website, such as website 122 (that is onboarded with a rewards program administered by payment application 142). Furthermore, based on determining that the first merchant is onboarded with the rewards program, payment application 142 is capable of updating a rewards total associated with the user of device 110. In addition, based on the user of device 110 accessing a checkout page of a second merchant website, such as website 152, (where the second merchant is not onboarded with the rewards program), payment application 142 is capable of determining if a user interface element associated with payment application 142 has been selected by the user of device 110. If the user interface element on the second merchant website has been selected, payment application 142 is capable of allowing the user of device 110 to make a purchase with the second merchant within an interface provided by payment application 142. Payment application 142 is described in more detail with regard to the figures.

Furthermore, in one or more embodiments, payment application 142 may utilize an application programming interface (API) in communicating with other programs, and further in communicating with database 144 and/or database 146.

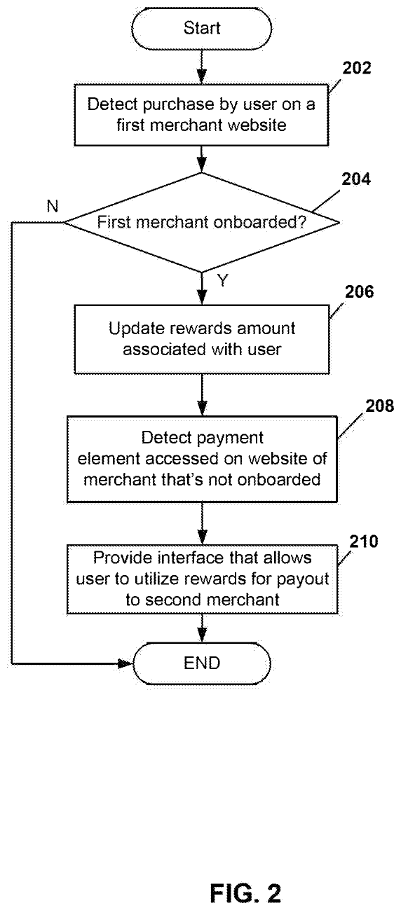

FIG. 2 is a flowchart illustrating the operations of payment application 142 in providing an interface for a user to utilize a rewards program to make a purchase with a merchant that is not part of the rewards program, in accordance with an embodiment. In the example embodiment, payment application 142 may detect a purchase by a user, such as the user of device 110, on a first merchant website, such as website 122 (step 202). In the example embodiment, the user of device 110 may utilize payment application 142 (via client payment application 112) to make the purchase on the first merchant website and payment application 142 may detect the purchase by detecting reception of the payment request from device 110 (or from the reception of a payment request from a merchant device). In other embodiments, payment application 142 may monitor the activity of the user of device 110 via client payment application 112 in order to detect that the user is making a purchase on the first merchant website.

In the example embodiment, payment application 142 may determine if the first merchant has been onboarded with a rewards program (or one or more rewards programs) that is managed/administered by payment application 142 (decision 204). In the example embodiment, payment application 142 may reference database 146 to determine if the first merchant has been onboarded with a rewards program managed by payment application 142. In the example embodiment, as stated above, database 146 may include merchant information including an indication as to whether a merchant is onboarded with a rewards program managed by payment application 142.

If payment application 142 determines that the first merchant has not onboarded with a rewards program that is managed by payment application 142 (based on an indication in database 146 or based on a lack of information corresponding to the first merchant in database 146) (decision 204, “NO” branch), payment application 142 may continue to monitor user activity of the user of device 110. If payment application 142 determines that the first merchant has been onboarded with a rewards program that is managed by payment application 142 (decision 204, “YES” branch), payment application 142 may update a rewards amount associated with the user of device 110 based on the detected purchase (step 206). In the example embodiment, payment application 142 may refer to database 146 to determine a rewards scheme associated with the first merchant to determine a correct amount of rewards (such as points) to allocate to the user of device 110 based on the detected purchase. For example, the first merchant may alter a rewards scheme for a period of time or for a specific item to entice users to make purchases. In the example embodiment, payment application 142 may then allocate the cost of the rewards provided to the user of device 110 to the first merchant.

In other embodiments, rather than monitoring user activity on device 110 to detect a purchase by the user on the first merchant website, based on the first merchant being onboarded with a rewards program that is managed by payment application 142, payment application 142 may monitor transactional activity corresponding to the first merchant (such as transactional activity on website 122) in order to determine if a rewards total associated with a transacting user needs to be updated.

In additional embodiments, payment application 142 may also monitor activity corresponding to the user of device 110 to detect a purchase by the user in a merchant physical location. In other words, payment application 142 may detect a purchase by the user in a merchant physical location (such as by way of detecting a payment request received from device 110 or a merchant device), and based on detecting the purchase, may update a rewards total in the same manner as described above.

In the example embodiment, payment application 142 may detect that a payment user interface element corresponding to payment application 142 located on a website of a second merchant (that is not onboarded with a rewards program that is managed by payment application 142) (step 208). In the example embodiment, the user of device 110 may access a checkout page of a second merchant website, such as website 152, that is not onboarded with a rewards program managed by payment application 142. However, payment application 142 may be a payment option on the website of the second merchant, and therefore, a user interface element corresponding to payment application 142 may be provided on the checkout page of the second merchant website. Payment application 142 may detect that the user of device 110 has accessed the user interface element corresponding to payment application 142, and based on detecting that the user of device 110 has accessed the user interface element corresponding to payment application 142, payment application 142 may provide an interface that allows the user of device 110 to utilize accumulated rewards from a rewards program managed by payment application 142 to make a purchase on the second merchant website (step 210). In the example embodiment, providing the interface may include causing client payment application 112 to launch on device 110, with the interface including purchase information and rewards information. Furthermore, payment application 142 may allow the purchase may be completed within the interface (such as by utilizing rewards).

In other embodiments, payment application 142 may allow for the usage of accumulated rewards in a physical location of the second merchant (that is not onboarded with a rewards program that is managed by payment application 142). For example, payment application 142 may detect a payment request from device 110 or from a device associated with the second merchant, and based on receiving the payment request, may provide an interface to the user of device 110 within client payment application 112 that may allow for the selection of accumulated rewards to complete the purchase.

In the example embodiment, payment application 142 may determine an amount of rewards that corresponds to the purchase amount based on utilizing a default rewards to currency conversion scheme. In the example embodiment, an administrator associated with payment application 142 may determine the default rewards to currency conversion scheme. In additional embodiments, the rewards to currency conversion scheme may be based on factors such as purchase category, the merchant, the type of merchant, a purchase amount, or based on an item being purchased. In one or more embodiments, payment application 142 may analyze the purchase to determine an appropriate rewards to currency conversion scheme based on one or more of the factors listed above.

Once the appropriate rewards to currency conversion scheme is identified, payment application 142 may prompt the user of the conversion scheme. The user may then provide input as to how much of the purchase price to pay with rewards. Upon receiving the input from the user, payment application 142 may process the purchase utilizing the identified amount of rewards and further may update a rewards amount associated with the user to reflect the purchase.

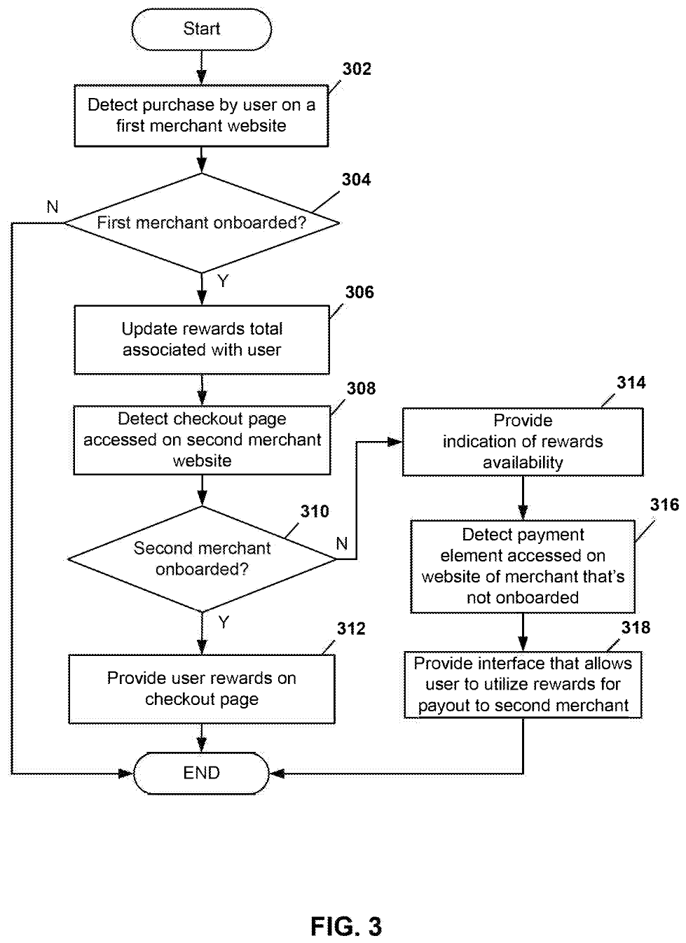

FIG. 3 is a flowchart illustrating the operations of payment application 142 in providing an indication of rewards availability to a user within an interface of a merchant that is not associated with the rewards program, in accordance with an embodiment.

In the example embodiment, payment application 142 may detect a purchase by a user, such as the user of device 110, on a first merchant website, such as website 122 (step 302). In the example embodiment, the user of device 110 may utilize payment application 142 (via client payment application 112) to make the purchase on the first merchant website and payment application 142 may detect the purchase by detecting reception of the payment request from device 110 (or from the reception of a payment request from a merchant device). In other embodiments, payment application 142 may monitor the activity of the user of device 110 via client payment application 112 in order to detect that the user is making a purchase on the first merchant website.

In the example embodiment, payment application 142 may determine if the first merchant has been onboarded with a rewards program (or one or more rewards programs) that is managed/administered by payment application 142 (decision 304). In the example embodiment, as stated above, payment application 142 may reference database 146 to determine if the first merchant has been onboarded with a rewards program managed by payment application 142. In the example embodiment, as stated above, database 146 may include merchant information including an indication as to whether a merchant is onboarded with a rewards program managed by payment application 142.

If payment application 142 determines that the first merchant has not onboarded with a rewards program that is managed by payment application 142 (based on an indication in database 146 or based on a lack of information corresponding to the first merchant in database 146) (decision 304, “NO” branch), payment application 142 may continue to monitor user activity of the user of device 110. If payment application 142 determines that the first merchant is onboarded with a rewards program that is managed by payment application 142 (decision 304, “YES” branch), payment application 142 may update a rewards amount associated with the user of device 110 based on the detected purchase, in a similar manner as described above (step 306).

In other embodiments, as stated above, rather than monitoring user activity on device 110 to detect a purchase by the user on the first merchant website, based on the first merchant being onboarded with a rewards program that is managed by payment application 142, payment application 142 may monitor transactional activity corresponding to the first merchant (such as transactional activity on website 122 or via reception of payment request from a merchant device) in order to determine if a rewards total associated with a transacting user needs to be updated.

In additional embodiments, as stated above, payment application 142 may also monitor activity corresponding to the user of device 110 to detect a purchase by the user hi a merchant physical location. In other words, payment application 142 may detect a purchase by the user in a merchant physical location (such as by way of detecting a payment request received from device 110 or a merchant device), and based on detecting the purchase, may update a rewards total in the same manner as described above.

In the example embodiment, payment application 142 may detect that the user of device 110 has accessed a checkout page associated with a website of a second merchant (step 308), In the example embodiment, payment application 142 may monitor the activity of the user of device 110 via client payment application 112 in order to detect that the user has accessed a checkout page associated with a website of a second merchant. In other embodiments, rather than monitoring user activity on device 110, payment application 142 may monitor activity associated with the website of the second merchant to determine that the user of device 110 has accessed the checkout page.

In the example embodiment, payment application 142 may determine if the second merchant has been onboarded with a rewards program (or one or more rewards programs) that is managed/administered by payment application 142 (decision 310). In the example embodiment, as stated above, payment application 142 may reference database 146 to determine if the second merchant is onboarded with a rewards program managed by payment application 142.

If payment application 142 determines that the second merchant has been onboarded with a rewards program that is managed by payment application 142 (decision 310, “YES” branch), payment application 142 may provide user rewards information on the checkout page of the second merchant website (step 312). In the example embodiment, by opting in to the rewards program managed by payment application 142, the second merchant may provide payment application 142 with control over a portion of the checkout, page. Therefore, payment application 142 may, upon determining that the second merchant has been onboarded, provide rewards information on the checkout page of the second merchant website when it is rendered to the user of device 110.

If payment application 142 determines that the second merchant has not been onboarded with a rewards program that is managed by payment application 142 (decision 310, “NO” branch), payment application 142 may provide an indication of rewards availability to the user of device 110 (step 314). In the example embodiment, payment application 142 may provide an indication of rewards availability by way of causing an interface, such as a popup, to launch, with the interface providing rewards information associated with the user, and further providing rewards availability information with regard to the second merchant. In other embodiments, payment application 142 may provide an indication of rewards availability within the checkout page (via a portion of the checkout page that is controlled by payment application 142). In further embodiments, if payment application 142 maintains control over a user interface element such as payment button on the checkout page of the second merchant website, payment application 142 may cause the user interface element corresponding to payment application 142 to change to indicate rewards availability. For example, payment application 142 may render the user interface element in a different color, a different font, to include different information, or may render another variation of the user interface element in order to indicate rewards availability.

In the example embodiment, payment application 142 may determine that a user interface element associated with payment application 142 located on a website of the second merchant has been accessed (step 316). In the example embodiment, as stated above, the user of device 110 may access a checkout page of a second merchant website, such as website 152, that is not onboarded with a rewards program managed by payment application 142. However, payment application 142 may be a payment option on the website of the second merchant, and therefore, a user interface element corresponding to payment application 142 may be provided on the checkout page of the second merchant website. Payment application 142 may detect that the user of device 110 has accessed the user interface element corresponding to payment application 142, and based on detecting that the user of device 110 has accessed the user interface element corresponding to payment application 142, payment application 142 may provide an interface that allows the user of device 110 to utilize accumulated rewards from a rewards program managed by payment application 142 to make a purchase on the second merchant website (step 318). In the example embodiment, providing the interface may include causing client payment application 112 to launch on device 110, with the interface including purchase information and rewards information. Furthermore, payment application 142 may allow the purchase may be completed within the interface (such as by utilizing rewards).

In other embodiments, as stated above, payment application 142 may allow for the usage of accumulated rewards in a physical location of the second merchant (that is not onboarded with a rewards program that is managed by payment application 142). For example, payment application 142 may detect a payment request from device 110 or from a device associated with the second merchant, and based on receiving the payment request, may provide an interface to the user of device 110 within client payment application 112 that may allow for the selection of accumulated rewards to complete the purchase.

In the example embodiment, as stated above, payment application 142 may determine an amount of rewards that corresponds to the purchase amount based on utilizing a default rewards to currency conversion scheme. Once the appropriate rewards to currency conversion scheme is identified, payment application 142 may prompt the user of the conversion scheme. The user may then provide input as to how much of the purchase price to pay with rewards. Upon receiving the input from the user, payment application 142 may process the purchase utilizing the identified amount of rewards and further may update a rewards amount associated with the user to reflect the purchase.

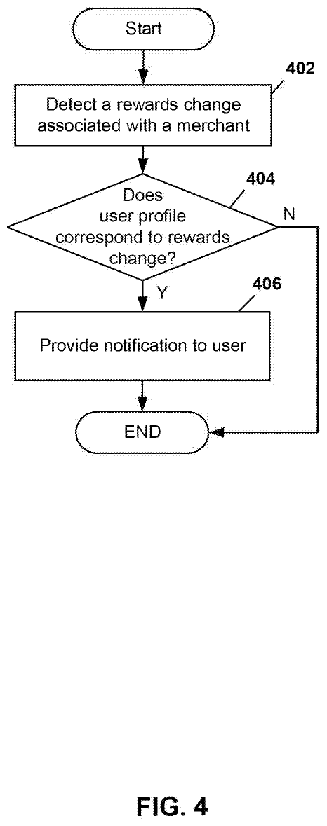

FIG. 4 is a flowchart illustrating the operations of payment application 142 in determining if a change to a rewards program corresponds to a profile of a user, in accordance with an embodiment. In the example embodiment, payment application 142 may detect a change to a rewards scheme corresponding, to a merchant, such as the merchant associated with website 122, that, is onboarded with a rewards program managed/administered by payment application 142 (step 402). In the example embodiment, payment application 142 may provide merchants onboarded with a rewards program managed by payment application 142 with an interface that the merchant can utilize to access and view user transactions, rewards that have been accumulated, and also to change one or more aspects of the rewards scheme associated with the merchant. Therefore, payment application 142 may detect a change to a rewards scheme via input from a corresponding merchant. In the example embodiment, the change to the rewards scheme may include a change as to the number of points/rewards that a user receives per unit of currency when making a purchase, the number of points/rewards that a user receives when making specific purchases (such as specific items, during a specific time period, a specific number of items, purchases made by a group), a change as to the utilization of accumulated rewards for a purchase (or for a specific purchase such as for a specific item), or another form of change to a rewards scheme.

In the example embodiment, payment application 142 determines if the user profile of the user of device 110 corresponds to the detected change to the rewards scheme corresponding to the merchant associated with website 122 (decision 404). In the example embodiment, payment application 142 may reference database 144 and identify if one or more attributes of the profile of the user of device 110 corresponds to the changes to the rewards scheme. For example, if the change in the rewards scheme involves a particular product or category of product, payment application 142 may reference the user profile of the user of device 110 and determine if the user profile corresponds to the particular product or category. For example, payment application 142 may determine that the user profile corresponds to the particular product or category if the user profile indicates the user of device 110 is interested in the particular product or category or if the user has recently or frequently purchased the particular product or one or more products from the category of products. In another example, payment application 142 may determine if the user profile corresponds to the particular merchant associated with the rewards scheme change (by way of recent purchases, like/dislikes, interests, etc.). In a further example, payment application 142 may determine if one or more items saved to a digital shopping cart that is associated with the user of device 110 corresponds to the rewards scheme change. For example, if a merchant changes a rewards scheme with regard to a particular product and the product is saved in a digital shopping cart of the user of device 110, payment application 142 may determine that the user profile of device 110 corresponds to the rewards scheme change.

If payment application 142 determines that the user profile of the user of device 110 does not correspond to the detected change to the rewards scheme corresponding to the merchant associated with website 122 (decision 404, “NO” branch), payment application 142 may continue to monitor for additional rewards scheme changes.

If payment application 142 determines that the user profile of the user of device 110 corresponds to the detected change to the rewards scheme corresponding to the merchant associated with website 122 (decision 404, “YES” branch), payment application 142 may provide a notification to the user of device 110 that corresponds to the rewards scheme change (step 406). In the example embodiment, payment application 142 may provide a notification via an email, an SMS, or within client application 112. Furthermore, if the rewards scheme change pertains to a particular product or category, payment application 142 may include information corresponding to the particular product as well as the rewards change.

While the determination performed in FIG. 4 provides an example (on a singular level) of determining a correlation with a profile of the user of device 110 and providing a notification based on the correlation, the determination may be performed for all users in database 144, and further a notification may be transmitted to all users that correspond to the change in the rewards scheme.

In one or more embodiments, a change to a rewards scheme by a merchant may be in an effort to promote the rewards program, based on accumulation of inventory of a particular item (point redemption value may be increased to create more demand for item), or to achieve another business or promotional objective.

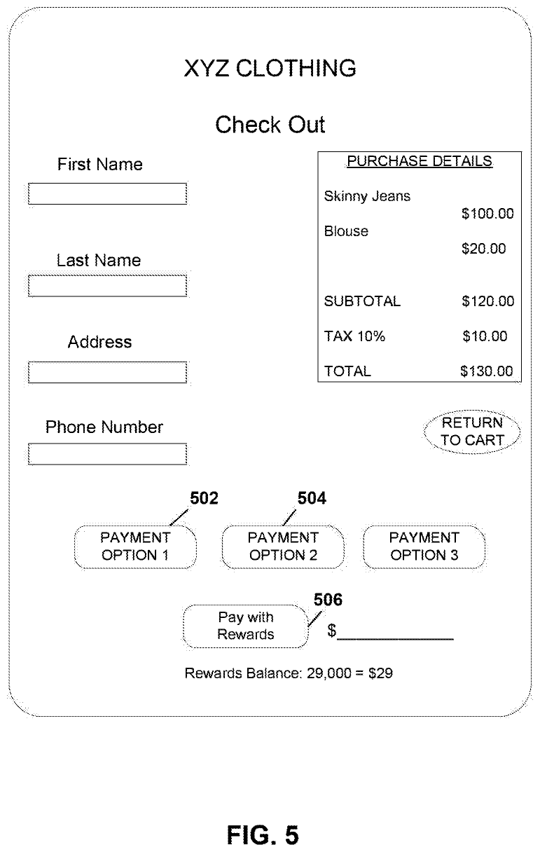

FIG. 5 is a depiction of a checkout page on a merchant website that includes an option to utilize rewards for a purchase, in accordance with an embodiment. In the example embodiment, FIG. 5 includes a checkout page that provides multiple payment options, such as payment option 502 and payment option 504, as well as an option to pay with rewards, rewards element 506. In the example embodiment, payment application 142 may provide rewards information, as shown in FIG. 5, and further may provide an option for the user to input an amount of the purchase to pay with rewards. In the example embodiment, FIG. 5 depicts a checkout page for a merchant that has opted into a rewards program that is managed by payment application 142. Therefore, payment application 142 may provide an option for a user to utilize rewards for a purchase directly on the merchant website.

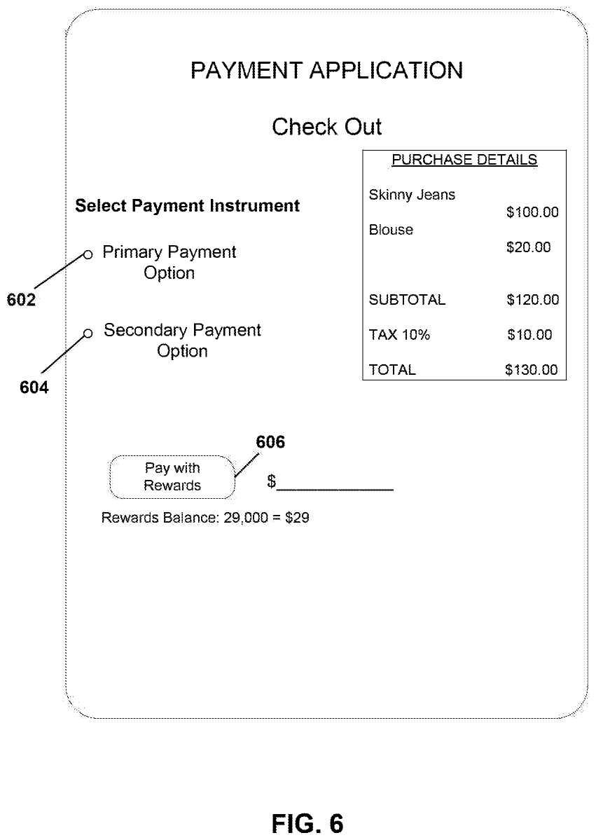

FIG. 6 is a depiction of an interface provided by payment application 142 that allows a user to utilize rewards to pay with a merchant that is not onboarded with the rewards program, in accordance with an embodiment. In the example embodiment, payment application 142 depicts an interface that may be provided to the user of device 110 within client payment application 112. For example, in response to the user of device 110 selected a user interface element that corresponds to payment application 142, payment application 142 may cause the depicted interface to be launched within client payment application 112. Furthermore, FIG. 6 depicts an interface that includes purchase details for a purchase to be made with a merchant that is not onboarded with a rewards program managed by payment application 142, payment option 602, payment option 604, and an option to pay with rewards using rewards 606. In addition, in the example embodiment, payment application 142 may provide rewards information, as shown in FIG. 6, and further may provide an option for the user to input an amount of the purchase to pay with rewards.

In addition, while the above Figures discuss rewards being accumulated and redeemed on merchant websites, in other embodiments, payment application 142 may allow for rewards to be accumulated and redeemed on merchant applications (such as a mobile app) in the same manner as described above. Further, payment application 142 may be a website and/or may provide an interface to the user (such as the interface depicted in FIG. 6), via a webpage displayed on browser 114. Therefore, if the user of device 110 selects a payment user interface element corresponding to payment application 142 within a merchant website or merchant application, payment application 142 may cause a webpage to be provided to the user of device 110, via browser 114, that may allow the user of device 110 to utilize accumulated rewards to make a purchase with a merchant that is not onboarded with a rewards program managed by payment application 142 (similar to the interface depicted in FIG. 6).

Furthermore, while the above Figures describe the accumulation of rewards being in relation to purchases with a merchant (such as an onboarded merchant), in one or more embodiments, payment application 142 may provide for the accumulation of rewards based on one or more user activities. For example, an onboarded merchant may transmit information to payment application 142 that includes one or more user activities that correspond to rewards (such as a check-in at a merchant location, or activity on a social media page of the merchant). Based on detection of the identified one or more user activities, payment application 142 may update a rewards total associated with an associated user.

In addition, in one or more embodiments, the rewards program managed/administered by payment application 142 may be maintained on one Or more blockchains.

The foregoing description of various embodiments of the present disclosure has been presented for purposes of illustration and description. It is not intended to be exhaustive nor to limit the disclosure to the precise form disclosed. Many modifications and variations are possible. Such modifications and variations that may be apparent to a person skilled in the art of the disclosure are intended to be included within the scope of the disclosure as defined by the accompanying claims.

Furthermore, this specification includes references to “the example embodiment,” “other embodiments,” “one or more embodiments, “further embodiments”, “additional embodiments”, and the like. The appearances of these phrases do not necessarily refer to the same embodiment. Particular features, structures, or characteristics may be combined in any suitable manner consistent with this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features.

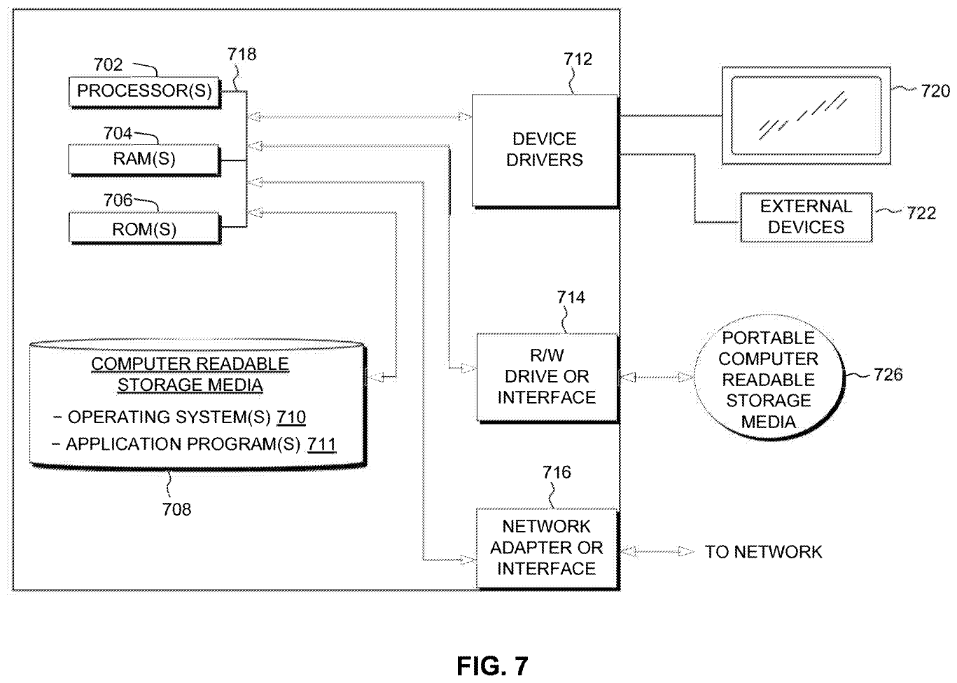

FIG. 7 depicts a block diagram of components of computing devices contained in rewards system 100 of FIG. 1, in accordance with an embodiment. It should be appreciated that FIG. 7 provides only an illustration of one implementation and does not imply any limitations with regard to the environments in which different embodiments may be implemented. Many modifications to the depicted environment may be made.

Computing devices may include one or more processors 702, one or more computer-readable RAMs 704, one or more computer-readable ROMs 706, one or more computer readable storage media 708, device drivers 712, read/write drive or interface 714, network adapter or interface 716, all interconnected over a communications fabric 718. Communications fabric 718 may be implemented with any architecture designed for passing data and/or control information between processors (such as microprocessors, communications and network processors, etc.), system memory, peripheral devices, and any other hardware components within a system.

One or more operating systems 710, and one or more application programs 711, for example, payment application 142, are stored on one or more of the computer readable storage media 708 for execution by one or more of the processors 702 and by utilizing one or more of the respective RAMs 704 (which typically include cache memory). In the illustrated embodiment, each of the computer readable storage media 708 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing devices may also include a R/W drive or interface 714 to read from and write to one or more portable computer readable storage media 726. Application programs 711 on the computing devices may be stored on one or more of the portable computer readable storage media 726, read via the respective R/W drive or interface 714 and loaded into the respective computer readable storage media 708.

Computing devices may also include a network adapter or interface 716, such as a TCP/IP adapter card or wireless communication adapter (such as a 4G wireless communication adapter using OFDMA technology). Application programs 711 on, the computing devices may be downloaded to the computing, devices from an external computer or external storage device via a network (for example, the Internet, a local area network or other wide area network or wireless network) and network adapter or interface 716. From the network adapter or interface 716, the programs may be loaded onto computer readable storage media 708. The network may comprise copper wires, optical fibers, wireless transmission, routers, firewalls, switches, gateway computers and/or edge servers.

Computing devices may also include a display screen 720, and external devices 722, which may include, for example a keyboard, a computer mouse and/or touchpad. Device drivers 712 interface to display screen 720 for imaging, to external devices 722, and/or to display screen 720 for pressure sensing of alphanumeric character entry and user selections. The device drivers 712, R/W drive or interface 714 and network adapter or interface 716 may comprise hardware and software (stored on computer readable storage media 708 and/or ROM 706).

The programs described herein are identified based upon the application for which they are implemented in a specific embodiment. However, it should be appreciated that any particular program nomenclature herein is used merely for convenience, and thus the disclosure should not be limited to use solely in any specific application identified and/or implied by such nomenclature.

Based on the foregoing, a computer system, method, and computer program product have been disclosed. However, numerous modifications and substitutions can be made without deviating from the scope of the present disclosure. Therefore, the various embodiments have been disclosed by way of example and not limitation.

Various embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area, network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer system, comprising:
one or more computer-readable memories storing program instructions; and
one or more processors configured to execute the program instructions to cause the system to perform operations comprising:
in response to detecting a first purchase or a user activity by a first user and corresponding to a first merchant, updating a rewards amount associated with the first user, wherein the first merchant corresponds to a first rewards program;
detecting an initiation of a second purchase by the first user, the purchase corresponding to a second merchant, wherein the second merchant does not correspond to the first rewards program;
in response to the detecting the initiation of the second purchase, causing an interface to be provided to the first user, wherein the interface allows the first user to utilize at least a portion of the rewards amount for the second purchase; and
in response to receiving an input from the first user via the provided interface, processing a payment for the second purchase, wherein at least a first portion of the rewards amount is utilized for the payment.

2. The computer system of claim 1, wherein the detecting the first purchase or the user activity includes detecting a payment request from a device of the first user or a device of the first merchant.

3. The computer system of claim 1, wherein the detecting the first purchase or the user activity includes detecting a check-in by the first user at a physical location of the first merchant.

4. The computer system of claim 1, wherein the detecting the initiation of the second purchase includes detecting a selection of a user interface element on a webpage or application page associated with the second merchant, wherein the user interface element corresponds to a payment service provider that is associated with the first rewards program, and wherein the interface provided to the first user corresponds to the payment service provider.

5. The computer system of claim 1, the operations further comprising:
in response to detecting an accessing of a checkout page associated with the second merchant, providing an indication of rewards availability for the second purchase.

6. The computer system of claim 5, wherein the providing the indication of rewards availability includes altering a user interface element on the checkout page, the user interface element corresponds to a payment service provider associated with the first rewards program.

7. The computer system of claim 6, wherein the altering the user interface element on the checkout page includes altering a font associated with the user interface element, altering information provided in association of the user interface element, or replacing the user interface element with an alternative user interface element.

8. A non-transitory computer-readable medium storing computer-executable instructions, that in response to execution by one or more hardware processors, causes the one or more hardware processors to perform operations comprising:
in response to detecting a first purchase or a user activity by a first user and corresponding to a first merchant, updating a rewards amount associated with the first user, wherein the first merchant is onboarded with a first rewards program;
detecting an initiation of a second purchase by the first user, the purchase corresponding to a second merchant, wherein the second merchant is not onboarded with the first rewards program;
in response to the detecting the initiation of the second purchase, causing an interface to be provided to the first user, wherein the interface allows the first user to utilize at least a portion of the rewards amount for the second purchase; and
in response to receiving an input from the first user via the provided interface, processing a payment for the second purchase, wherein at least a first portion of the rewards amount is utilized for the payment.

9. The non-transitory computer-readable medium of claim 8, wherein the detecting the first purchase or the user activity includes detecting a payment request from a device of the first user or a device of the first merchant.

10. The non-transitory computer-readable medium of claim 8, wherein the detecting the first purchase or the user activity includes: detecting a user activity in a physical merchant location, wherein the user activity corresponds to one or more user activities identified by the first merchant.

11. The non-transitory computer-readable medium of claim 8, wherein the detecting the initiation of the second purchase includes detecting a selection of a user interface element on a webpage or application page associated with the second merchant, wherein the user interface element corresponds to a payment service provider that is associated with the first rewards program, and wherein the interface provided to the first user corresponds to the payment service provider.

12. The non-transitory computer-readable medium of claim 8, the operations further comprising:
in response to detecting a checkout page associated with the second merchant being accessed, providing an indication of rewards availability for the second purchase.

13. The non-transitory computer-readable medium of claim 12, wherein the providing the indication of rewards availability includes altering a user interface element on the checkout page, the user interface element corresponds to a payment service provider associated with the first rewards program.

14. The non-transitory computer-readable medium of claim 13, wherein the providing the indication of rewards availability includes causing a notification to be provided to the first user that includes rewards information.

15. A method, comprising:
in response to detecting a first purchase or a user activity by a first user and corresponding to a first merchant, updating, by a computer system, a rewards amount associated with the first user, wherein the first merchant corresponds to a first rewards program;
in response to detecting an accessing of a checkout page of a webpage or application page of a second merchant, determining, by the computer system, if the second merchant corresponds to the first rewards program;
in response to the determining that the second merchant does not correspond to the first rewards program, causing, by the computer system, an indication of a rewards availability for the second merchant to be provided to the first user;
in response to detecting an initiation of a second purchase, causing, by the computer system, an interface to be provided to the first user, wherein the interface provides a selectable option that corresponds to utilizing at least a portion of the rewards amount for the second purchase; and
in response to receiving an input from the first user via the provided interface, processing, by the computer system, a payment for the second purchase, wherein at least a first portion of the rewards amount is utilized for the payment.

16. The method of claim 15, wherein the detecting the first purchase or the user activity includes detecting, by the computer system, a payment request from a device of the first user or a device of the first merchant.

17. The method of claim 15, wherein the detecting the first purchase or the user activity includes detecting, by the computer system, a check-in by the first user at a physical location of the first merchant.

18. The method of claim 15, further comprising:
updating, by the computer system, the rewards amount associated with the first user based on the second purchase.

19. The method of claim 15, wherein the providing the indication of rewards availability includes causing, by the computer system, a notification to be provided to the first user that includes rewards information.

20. The method of claim 15, wherein the processing the payment for the second purchase includes accessing, by the computer system, a database to identify a rewards conversion scheme corresponding to the second merchant and the second purchase.
